(19) United States
(12) Patent Application Publication
(10) Pub. No.: US 2010/0323073 A1
(43) Pub. Date: Dec. 23, 2010

(54) FRESHWATER DIATOMACEOUS EARTH PRODUCTS CONTAINING REDUCED SOLUBLE METAL LEVELS, PROCESSES FOR REDUCING SOLUBLE METAL LEVELS IN FRESHWATER DIATOMACEOUS EARTH PRODUCTS, AND METHODS OF USING THE SAME

(76) Inventor: Jie Lu, Lompoc, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/863,142

(22) PCT Filed: Jan. 16, 2009
(86) PCT No.: PCT/US09/31194

§ 371 Date: Aug. 20, 2010

Related U.S. Application Data
(60) Provisional application No. 61/022,765, filed on Jan. 22, 2008.

(51) Int. Cl. C12H 1/04; B01D 15/04; B01J 20/22

(52) U.S. Cl. 426/271; 210/638; 502/401

(57) ABSTRACT

Disclosed herein are freshwater diatomaceous earth products containing reduced soluble metal levels, processes for reducing soluble metal levels in freshwater diatomaceous earth products, and methods of using the same. In particular, freshwater diatomaceous earth products are disclosed that have been treated with at least one surface metal blocking agent, such as an organic silicone compound with at least one functional group capable of forming a chelating complex with metal ions, to reduce the level of soluble metals associated therewith. Such freshwater diatomaceous earth products containing reduced soluble metal levels may be useful for various applications including as filter aid materials.

### CLAIM OF PRIORITY

This PCT International Application claims the benefits of and rights of priority to U.S. Provisional Patent Application No. 61/022,765 filed Jan. 22, 2008, which is incorporated by reference herein in its entirety.

### FIELD OF THE INVENTION

Disclosed herein are freshwater diatomaceous earth products containing reduced soluble metal levels, processes for reducing soluble metal levels in freshwater diatomaceous earth products, and methods of using the same. In particular, freshwater diatomaceous earth products are disclosed that have been treated with at least one surface metal blocking agent to reduce the level of soluble metals associated therewith. For example, the at least one surface metal blocking agent is at least one organic silicone compound with at least one functional group capable of forming a chelating complex with metal ions. Such freshwater diatomaceous earth products containing reduced soluble metal levels may be useful for various applications, including for example as filter aid materials.

### BACKGROUND OF THE INVENTION

Diatomaceous earth products are obtained from diatomaceous earth (also called “DE” or “diatomite”), which is generally regarded as a sediment enriched in biogenic silica (i.e., silica produced or brought about by living organisms) in the form of siliceous skeletons (frustules) of diatoms. Diatoms are a diverse array of microscopic, single-celled, golden-brown algae of the class Bacillariophyceae that possess an ornate siliceous skeleton of varied and intricate structures comprising two valves that, in the living diatom, fit together much like a pill box.

Diatomite may form from the remains of water-borne diatoms and, therefore, diatomite deposits may be found close to either current or former bodies of water. Those depositions are generally divided into two categories based upon source: freshwater and saltwater. Freshwater diatomite is generally mined from dry lakebeds and may be characterized as having a low crystalline silica content and a high iron content. In contrast, saltwater diatomite is generally extracted from oceanic areas and may be characterized as having a high crystalline silica content and a low iron content.

In the field of filtration, methods of particle separation from fluids may employ diatomite products as filter aids. The intricate and porous structure unique to diatomite may, in some instances, be effective for the physical entrapment of particles in filtration processes. It is known to employ diatomite products to improve the clarity of fluids that exhibit turbidity or contain suspended particles or particulate matter.

Diatomite may be used in various embodiments of filtration. As a part of precoating, diatomite products may be applied to a filter septum to assist in achieving, for example, any one or more of: protection of the septum, improvement in clarity, and expediting of filter cake removal. As a part of body feeding, diatomite may be added directly to a fluid that is being filtered in order to assist in achieving, for example, either or both of: increases flow rate and extensions of the filtration cycle. Depending on the requirements of the specific separation process, diatomite may be used in multiple stages or embodiments, for example, both in pre-coating and in body feeding.

Diatomite filter aids may also comprise metals, such as iron, that may be soluble in the liquid media being filtered. When those diatomite filter aids are used to filter liquids, the metals may disassociate and enter the liquid media. In many applications, this increase in metal content of the liquid media may be undesirable or even unacceptable. For example, when diatomite filter aids may be used to filter beer, a high level of iron dissolved in the beer originating from the filter aid material may adversely affect sensory or other properties, such as taste and/or shelf-life. Other non-diatomite filter aids may suffer from a similar “metal leaching” effect. Thus, the brewery industry has long recognized the importance of reducing iron dissolution in beer and has sought out filter aids with increasingly lower beer soluble iron (“BSI”) contents.

The brewing industry has developed at least two protocols by which the BSI of DE filter aids may be measured. The European Beverage Convention (EBC) method contacts liquid potassium hydrogen phthalate with the filter aid and subsequently analyzes the liquid for iron content. The American Society of Brewing Chemists (ASBC) contacts a sample of beer with the filter aid and subsequently measures the resulting iron content in the beer.

More specifically, the EPC method uses, for example, a 10 g/L solution of potassium hydrogen phthalate (KHP, KHC₈H₄O₄) as the extractant along with a given quantity of filter aid material, with a total contact time of 2 hours. Extracts are then analyzed for iron concentration by the FERROZINE method.

The ASBC method may measure BSI content by placing a 5 g sample of a filter aid material in 200 mL of decarbonated beer (for example, BUDWEISER® from Anheuser-Busch, St. Louis, Mo., USA) at room temperature and swirling the mixture intermittently for an elapsed time of 5 min and 50 sec. The mixture is then immediately transferred to a funnel containing 25 cm diameter filter paper, from which the filtrate collected during the first 30 sec is discarded. Filtrate is collected for the next 150 sec, and a 25 mL portion is treated with approximately 25 mg of ascorbic acid (C₆H₈O₆) to reduce dissolved iron ions to the ferrous (Fe²⁺) state, thus yielding a “sample extract”). Color is then developed by addition of 1 mL of 0.3% (w/v) 1,10-phenanthroline and, after 30 min, the absorbance of the resulting sample solution is compared to a standard calibration curve. The calibration curve is prepared from standard solutions of known iron concentrations in beer. Untreated filtrate is used as a method blank to correct for turbidity and color. Absorbance is measured at 505 nm using a spectrophotometer and compared against the standard to measure BSI.

Methods have been developed in an effort to reduce the content of BSI in diatomite filter aids. One such method is simple crude diatomite selection. Because saltwater diatomites are generally lower in iron content than freshwater diatomites, they have traditionally been selected for use in filtration applications to minimize the introduction of iron into the liquid media. However, due to the limited amounts and/or availability of saltwater diatomites, crude selection alone may not be sufficient to supply industries such as the brewing industry with desired quantities of low BSI-level diatomite. Therefore, it would be desirable to find an inexpensive and effective way to reduce the amount of soluble metals, including BSI, in freshwater crude diatomite so that it may acceptably be used in filtration applications, such as beer filtration, that require low metal dissolution.

Prior attempts to reduce the amount of soluble metals in freshwater diatomites have proven to be expensive, inefficient, and/or ineffective. One such method used in an attempt to reduce BSI content in DE is calcination. Calcination generally comprises heating the diatomaceous earth at a high temperature, for example in excess of about 900° C. Calcination may reduce the presence of organics and volatiles in the diatomite, induce a color change from off-white to tan or pink, and allow the beer soluble iron content of the diatomite to decrease naturally and gradually with time after calcination. Such natural decrease generally involves, for example, surface re-hydration by humidity in the ambient air. However, to achieve sufficient levels of BSI reduction under such natural conditions may take months and the results may fluctuate with seasons and/or selection of crude DE.

Apart from or in addition to crude selection and calcination process control, chemicals may be applied to filter aids to reduce BSI content. Chemical processes include, for example, acid-washing and/or leaching with chelating solutions such as EDTA or citric acid. Although such methods can be somewhat effective to reduce surface soluble metals, the processes are usually expensive. In addition, highly soluble metals may re-emerge in the filter aids if abundant refreshed surfaces reappear during chemical or mechanical processing. Furthermore, in some applications, chemical treatments may be undesirable or unacceptable. For instance, in applications regulated by the U.S. Food and Drug Administration, water is the only chemical allowed in the post-calcination processing of filter aids without the chemical undesirably being labeled as an additive.

Water treatment may comprise, for example, spraying water to the bottom of a bulk container comprising filter aids or into bags during packaging. Water treatment at higher temperatures is known to accelerate the BSI reduction process, yet because water treatment generally occurs in an open container, the temperature of the treatment cannot be higher than the boiling point of water. Typical water treatments may include spraying and mixing water into a diatomite filter aid product while the product is hot (for example, at a temperature ranging from about 150° F. to about 200° F.). The treated product may be held in containers, such as bins and rail cars, until the BSI is reduced to the desired level. Water treatments may also comprise the use of steam treatment. However, the BSI reduction effects of water treatments are often limited in BSI reduction and, therefore, water-treatment cannot be used to effectively treat filter aids that have relative high BSI levels, such as freshwater diatomite.

Therefore, there exists a need for a low soluble metal containing freshwater diatomite filter aid product, as well as an inexpensive and effective method for reducing the amount of soluble metals in freshwater diatomite crudes, that may acceptably be used in applications that require low metal dissolution. The present inventors have surprisingly found that such a freshwater diatomite product containing reduced soluble metal levels may be achieved by treating freshwater diatomite with at least one surface metal blocking agent. In particular, the present inventors have discovered that the soluble metal content of a freshwater diatomite crude may be reduced by treatment with at least one organic soluble metal blocking agent comprising multiple functional groups capable of forming strong and durable chemical bonds with the freshwater diatomite silica surfaces and, at the same time, stable complexes with the metal species present on or near the diatomite surface.

### SUMMARY OF THE INVENTION

Disclosed herein are processes for decreasing the soluble metal content of a freshwater diatomaceous earth material. In one embodiment, the process comprises treating at least one freshwater diatomaceous earth feed material with at least one soluble metal blocking agent. In another embodiment, the beer soluble iron content of the at least one freshwater DE feed material may be reduced by treatment with the at least one soluble metal blocking agent by at least about 45%, as calculated by the EBC method. In a further embodiment, the BSI content of the at least one freshwater DE feed material may be reduced by treatment with the at least one soluble metal blocking agent by at least about 75%, as calculated by the ASBC method.

Also disclosed herein are treated freshwater DE products. In one embodiment, the treated products comprise at least one freshwater diatomaceous earth feed material and at least one soluble metal blocking agent.

Further disclosed herein are methods for filtering a liquid comprising passing the liquid through a filter membrane comprising a treated freshwater diatomaceous earth product comprising a freshwater DE material and at least one soluble metal blocking agent. In one embodiment, the liquid is selected from one of an oil and a beverage. In another embodiment, the liquid is a beer.

Further disclosed herein are methods for removal of at least one soluble metal from at least one liquid by contacting the liquid with at least one filter comprising at least one treated fresh water diatomaceous earth product. In one embodiment, the at least one liquid is selected from the group consisting of an oil and a beverage. In another embodiment, the at least one liquid is a beer.

### BRIEF DESCRIPTION OF THE FIGURES

FIG. 1 shows exemplary coupling and chelating effects of one surface metal blocking agent according to the present invention with the surface of a freshwater diatomite and a surface metal.

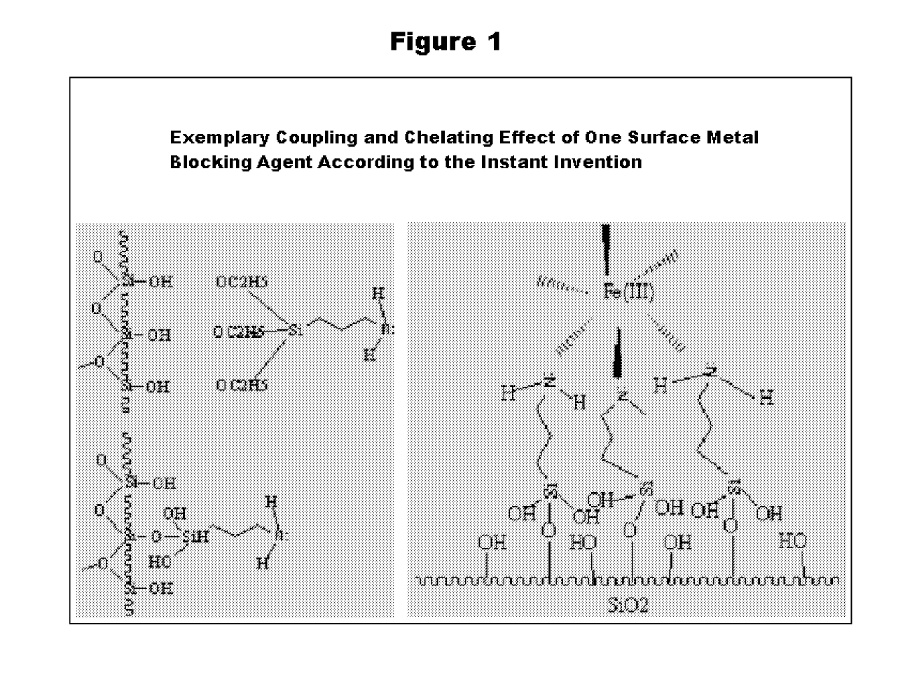

FIG. 2 shows the beer soluble iron content, according to the ASBC method, of an untreated sample of C577 freshwater diatomite versus the beer soluble iron content of a sample of C577 freshwater diatomite treated with the surface metal blocking agent Silquest® A1100 according to the present invention.

FIG. 3 shows the beer soluble iron content, according to the ASBC method, of an untreated sample of Kenite® 1000 freshwater diatomite versus the beer soluble iron content of a sample of Kenite® 1000 freshwater diatomite treated with the surface metal blocking agent Silquest® A1100 according to the present invention.

FIG. 4 shows the beer soluble iron content, according to the EBC method, of an untreated sample of Kenite® 1000 freshwater diatomite versus the beer soluble iron content of a sample of Kenite® 1000 freshwater diatomite treated with the surface metal blocking agent Silquest® A1100 according to the present invention.

FIG. 5 shows the aluminum and iron metal content of a beer after being filtered with a filter containing the freshwater diatomite Kenite® 1000 treated with varying amounts of the surface metal blocking agent Silquest® A1100 according to the present invention.

### DETAILED DESCRIPTION OF THE INVENTION

This application describes, in part, new methods for reducing soluble metals from freshwater diatomites, freshwater diatomite products having reduced soluble metal content, and methods for using such reduced soluble metal freshwater diatomites. In one embodiment, the freshwater diatomites may be used as filter aids and/or filter media made from particulate filter aids. In another embodiment, at least one freshwater diatomite is treated with at least one surface metal blocking agent, such that soluble metal ionic species are blocked from dissolution. In a further embodiment, the methods described herein eliminate or reduce soluble metals without affecting performance of the filter aids.

As used herein, the term “soluble metal” refers to any metal that may be dissolved in at least one liquid. Soluble metals include those known to one of ordinary skill in the art. Exemplary soluble metals include, but are not limited to, iron, aluminum, vanadium, chromium, copper, zinc, nickel, cadmium, and mercury.

As used herein, the term “surface metal blocking agent” refers to a substance that: (1) can form chemical bonds with the silica surfaces of a freshwater diatomite material, and (2) contains at least one functional group that can form stable complexes with metal species present on or near the surfaces of the freshwater diatomite. The dual functionality of a surface metal blocking agent allows the agent to block, at least partially, the dissolution of the surface metal species by forming relatively strong and durable coupling bonds with the siliceous surfaces of a freshwater diatomite material while also forming relatively strong and durable complexes with one or more metal ions that may be associated with the freshwater diatomite material. Thereby, the soluble metals can be effectively blocked on the surfaces of the freshwater diatomite and are not dissolved into liquid media.

In contrast, polydentate ligand chelating compounds (such as EDTA, citric acid, or ferrozine) mentioned in the prior art only form complexes with the soluble metal species and do not also bond to the diatomite silica surfaces. Therefore, those compounds are not capable of holding the soluble metal species onto the diatomite surface and are thus generally used only with solutions in leaching processes. If such polydentate compounds were to be used in non-leaching processes, such as filtration processes, they would tend to increase the soluble metals in the liquid to be filtered—not decrease them.

The at least one soluble metal blocking agent may be any chemical agent capable of forming a chelating complex with metal ions present in the at least one feed material and/or freshwater DE material, while remaining bound to the at least one freshwater DE material. In one embodiment, the at least one soluble metal blocking agent comprises at least one organic silicon component. Examples of the at least one organic silicon component include, but are not limited to, silanes, siloxanes, and silicones. In another embodiment, the at least one soluble metal blocking agent comprises at least one chelating functional group, which may be capable of forming a chelating complex with metal ions present in the at least one feed material. Examples of the at least one chelating functional group include, but are not limited to, amino, phenyl, azide, carboxylate, phosphonate, sulfonate, epoxy, glycidoxy, vinyl, methacryl, isocyanato, mercaptan, and hydroxy groups. Further examples of the at least one chelating functional group include, but are not limited to, any chemical moiety that can donate at least one electron pair to at least one metal ion (such as iron ions) to form stable complexes. In a further embodiment, the at least one soluble metal blocking agent comprises at least one organic silicon component and at least one chelating functional group. In yet another embodiment, the at least one soluble metal blocking agent comprises at least one organic silicon compound that can form at least one Si—-O—Si bond with at least one siliceous surface of the at least one DE material, and also at least one chelating functional group capable of forming at least one stable bond with at least one metal present in the at least one DE material.

In one embodiment, the at least one soluble metal blocking agent is chosen from the group consisting of: 3-aminopropyltriethoxysilane (which may be sold by OSi Specialties, Danbury, Conn., as Silquest® A1100); 3-glycidoxypropyltrimethoxysilane (which may be sold by OSi Specialties as Silquest® A187); 3,4-epoxycyclohexyl ethyltrimethoxy silane (which may also be sold by OSi Specialties as Silquest® A-186); N-(2-Aminoethyl)-3-aminopropyltrialkoxysilane (which may be sold by Wacker Chemie AG, Munich, Germany, as GENIOSIL GF 9); N-(Aminoethyl)-3-aminopropylmethyldialkoxysilane (which may be sold by Wacker Chemie AG as GENIOSIL GF 95); 3-ureidopropyltrialkoxysilane (which may be sold by Wacker Chemie AG as GENIOSIL GF 98); vinyltrialkoxysilane (which may be sold by Wacker Chemie AG as GENIOSIL XL 10 or GENIOSIL GF 56); vinyldimethoxymethylsilane (which may be sold by Wacker Chemie AG as GENIOSIL XL 12); vinyltris(2-methoxyethoxy)-silane (which may be sold by Wacker Chemie AG as GENIOSIL GF 58); vinyltriacetoxysilane (which may be sold by Wacker Chemie AG as GENIOSIL GF 62); (Methacryloxymethyl) methyldialkoxysilane (which may be sold by Wacker Chemie AG as GENIOSIL XL 32 or GENIOSIL XL 34); methacryloxymethyltrimethoxysilane (which may be sold by Wacker Chemie AG as GENIOSIL XL 33); methacryloxypropyltrialkoxysilane (which may be sold by Wacker Chemie AG as GENIOSIL XL 36); 3-Methacryloxypropyltrimethoxysilane (which may be sold by Wacker Chemie AG as GENIOSIL GF 31); 3-Methacryloxypropyltriacetoxysilane (which may be sold by Wacker Chemie AG as GENIOSIL GF 39); 3-Isocyanatopropyltrimethoxysilane (which may be sold by Wacker Chemie AG as GENIOSIL GF 40); (isocyanatomethyl)methyldimethoxysilane (which may be sold by Wacker Chemie AG as GENIOSIL XL 42); and, 3-Glycidoxypropylmethyldiethoxysilane (which may be sold by Wacker Chemie AG as GENIOSIL GF 84).

The at least one soluble metal blocking agent may be present in any and various amounts required or desired to produce a desired level of decreased soluble metal content. The amount of soluble metal blocking agent employed may also be varied depending upon the surface area of the freshwater DE product to be treated. In one embodiment, the at least one soluble metal blocking agent is present in an amount of from about 0.2% to about 2%, relative to the weight of the at least one freshwater diatomite material. In another embodiment, the at least one soluble metal blocking agent is present in an amount of from about 0.2% to about 1%. In a further embodiment, the at least one soluble metal blocking agent is present in an amount of from about 0.2% to about 0.6%. In yet another embodiment, the at least one soluble metal blocking agent is present in an amount of from about 0.4% to about 0.6%. In yet a further embodiment, the at least one soluble metal blocking agent is present in amount less than about 2.0%.

As used herein, the term “treated” or “treatment” refers to any form of contacting at least one freshwater diatomite material with at least one soluble metal blocking agent such that the at least one metal blocking agent bonds with the silica surfaces of the at least one freshwater diatomite material. In one embodiment, treatment comprises adding the at least one soluble metal blocking agent to a dry powder of the at least one freshwater DE material at ambient or elevated temperatures. In such an embodiment, the at least one soluble metal blocking agent may quickly bond to surfaces of the at least one freshwater DE material and to metal ions associated therewith. In another embodiment, treatment does not significantly affect the surface hydrophilicity of the freshwater DE material, such that treatment does not significantly affect the mixing properties and/or permeability of the freshwater DE material when used in liquid-solid separations.

The at least one freshwater diatomite material may be from one or more sources or types of freshwater DE. The resulting treated freshwater diatomite product may be tailored to a particular application by, in part, the selection of the DE material. In one embodiment, the at least one freshwater DE material is a commercially available freshwater diatomite product. In another embodiment, the at least one freshwater DE material has not been subjected to chemical or physical modification processes. In a further embodiment, the at least one freshwater DE material is a calcined or flux-calcined product. Calcined freshwater diatomite products, which may also be called pinks, are heat-treated freshwater diatomite products. Flux-calcined freshwater diatomite products are those calcined products that are heated in the presence of a flux, such as for example a fusible alkali salt. In yet another embodiment, the at least one freshwater DE material undergoes minimal processing following mining or extraction. In yet a further embodiment, the at least one freshwater DE material is subjected to at least one physical modification process chosen from milling, drying, and air classifying. In still another embodiment, the at least one freshwater DE material may be subjected to at least one physical or chemical modifying process or procedure that would be well known to one of skill in the art to assist in achieving a desired product.

Subsequent to or prior to being contacted with the surface metal blocking agent, the at least one freshwater DE material may undergo at least one processing step. In one embodiment, the powder size of the at least one freshwater DE material is adjusted to a suitable or desired size using any one of several techniques well known in the art. In another embodiment, the at least one freshwater DE material undergoes at least one mechanical separation to adjust the powder size distribution. Numerous mechanical separation techniques are known to the skilled artisan including, without limitation, milling, grinding, screening, extrusion, triboelectric separation, liquid classification, and air classification.

The metal content of the freshwater DE material, the treated freshwater DE material, a liquid, and/or a treated liquid may be measured by any one or more of various measurement techniques now known to the skilled artisan or hereafter discovered from the measurement of metal content in a liquid. Some measurement techniques may be specific to certain metals; thus, it may be necessary to perform more than one measurement technique in order to analyze the content of multiple metals. In one embodiment, the ASBC method is used to analyze metal content. In another embodiment, the EBC method is used to analyze metal content. In a further embodiment, a graphite furnace atomic absorption spectrometric (GFAA) method is used to analyze metal content.

As used herein, the term “beer soluble iron” is interchangeable with the acronym “BSI” and refers to the iron content, which may be measured in parts per million, of a filter aid that dissociates in the presence of a liquid, such as beer. It is often useful to measure the improved reduction in BSI in terms of percent reduction relative to a standard or un-treated material. In one embodiment, at least one treated freshwater DE material has a percent reduction in BSI ranging from about 75% to about 100% relative to the untreated freshwater DE material, as measured by the ASBC method. In another embodiment, the BSI percent reduction ranges from about 85% to about 100%, as measured by the ASBC method. In a further embodiment, the BSI percent reduction ranges from about 90% to about 100%, as measured by the ASBC method. In yet another embodiment, the BSI percent reduction ranges from about 95% to about 100%, as measured by the ASBC method. In still another embodiment, the BSI percent reduction ranges from about 99% to about 100%, as measured by the ASBC method. In still yet another embodiment, the BSI percent is reduced to a level where it becomes undetectable, as measured by the ASBC method.

In one embodiment, at least one treated freshwater DE material has a percent reduction in BSI ranging from about 45% to about 100% relative to the untreated freshwater DE material, as measured by the EBC method. In another embodiment, the BSI percent reduction ranges from about 65% to about 100%, as measured by the EBC method. In a further embodiment, the BSI percent reduction ranges from about 75% to about 100%, as measured by the EBC method. In yet another embodiment, the BSI percent reduction ranges from about 85% to about 100%, as measured by the EBC method. In yet a further embodiment, the BSI percent reduction ranges from about 95% to about 100%, as measured by the EBC method. In still yet another embodiment, the BSI percent is reduced to a level where it becomes undetectable, as measured by the EBC method.

In one embodiment, after treatment with at least one surface metal blocking agent according to the instant invention, the at least one treated freshwater DE material may possess a BSI level of less than about 5 ppm. In another embodiment, after treatment the material may possess a BSI level of less than about 2 ppm. In a further embodiment, after treatment the material may possess a BSI level of less than about 1 ppm.

Treated freshwater DE material according to the present invention may be used in any of a variety of processes and materials, including but not limited to filter compositions and catalyst compositions. An at least one treated freshwater DE material intended for use as a filter aid may be incorporated into a filter aid composition. The filter aid composition may optionally comprise at least one additional filter aid medium. Examples of suitable at least one additional filter aid medium include, but are not limited to, natural or synthetic silicate or aluminosilicate materials, unimproved freshwater diatomite, saltwater diatomite, expanded perlite, pumicite, natural glass, cellulose, activated charcoal, feldspars, nepheline syenite, sepiolite, zeolite, and clay. The at least one additional filter medium may be present from between about 0.01 to about 100 parts of at least one additional filter medium per part of treated freshwater DE material. In one embodiment, the at least one additional filter medium may be present from between about 0.1 to about 10 parts of at least one additional filter medium per part of treated freshwater DE material. In another embodiment, the at least one additional filter medium may be present from between about 0.5 to 5 parts of at least one additional filter medium per part of treated freshwater DE material.

In those embodiments in which the filter aid composition comprises at least one additional filter aid media, the at least one soluble metal blocking agent may be present in an amount of from about 10% to about 50%, relative to the weight of the at least one treated freshwater diatomite material. In one such embodiment, the at least one soluble metal blocking agent may be present in an amount of from about 25% to about 50%, relative to the weight of the at least one treated freshwater diatomite material. In another such embodiment, the at least one soluble metal blocking agent may be present in an amount of from about 35% to about 50%, relative to the weight of the at least one treated freshwater diatomite material.

The filter aid composition may be formed into sheets, pads, cartridges, or other monolithic or aggregate media capable of being used as supports or substrates in a filter process. Considerations in the manufacture of filter aid compositions may include a variety of parameters, including but not limited to total BSI of the composition, median BSI of the composition, particle size distribution, pore size, cost, and availability.

In one embodiment, a treated freshwater DE filter aid is applied to a filter septum to protect it and/or to improve clarity of the liquid to be filtered in a filtration process. In another embodiment, a treated freshwater DE filter aid is added directly to a beverage to be filtered to increase flow rate and/or extend the filtration cycle. In a further embodiment, the treated freshwater DE filter aid is used as pre-coating, in body feeding, or a combination of both pre-coating and body feeding, in a filtration process.

The treated freshwater DE filter aid products of the present invention may be used in a variety of filtering methods. In one embodiment, the method of filtering comprises pre-coating at least one filter element with at least one treated DE filter aid, and contacting at least one liquid to be filtered with the at least one coated filter element. In such an embodiment, the contacting may comprise passing the liquid through the filter element. In another embodiment, the method of filtering comprises suspending the treated freshwater DE filter aid in at least one liquid containing particles to be removed from the liquid, and subsequently separating the at least one freshwater DE filter aid from the filtered liquid.

Treated freshwater DE filter aids may be employed to filter various types of liquids, particularly those liquids that would be deleteriously affected by an increase in metal content during filtration. The skilled artisan would be readily aware of liquids that may be desirably filtered with a process comprising the treated freshwater DE filter aids disclosed herein. In one embodiment, the liquid is a beverage. Such beverages include, for example, vegetable-based juices, fruit juices, distilled spirits, and malt-based liquids. Exemplary malt-based liquids include, but are not limited to, beer and wine. In another embodiment, the liquid is one that tends to form haze upon chilling. In a further embodiment, the liquid is a beverage that tends to form haze upon chilling. In yet another embodiment, the liquid is a beer. In yet a further embodiment, the liquid is an oil. In still another embodiment, the liquid is an edible oil. In still a further embodiment, the liquid is a fuel oil. In yet another embodiment, the liquid is a water, including but not limited to waste water. In yet a further embodiment, the liquid is blood. In another embodiment, the liquid is a sake. Other suitable liquids include those now known or hereafter found to be suitable to those of ordinary skill in the art.

Also provided, in one embodiment, is a method not only to reduce soluble metal ions from the at least one freshwater DE diatomite itself, but also to reduce the soluble metal content of the at least one liquid media being filtered. Without wishing to be bound by theory, it is believed that, in addition to binding and blocking soluble metals associated with the surface of a freshwater diatomite, the at least one soluble metal blocking agent is also capable of extracting soluble metals from the at least one liquid media to be filtered and binding them to the surfaces of the at least one freshwater DE. By that mechanism, the soluble metal content of the liquid media itself may be reduced.

The treated freshwater DE products disclosed herein may also be used in applications other than filtration. In one embodiment, the treated products are used as composites in filler applications. In another embodiment, the treated products are used to alter the appearance and/or properties of paints, enamels, lacquers, or related coatings and finishes. In a further embodiment, the products also used in paper formulations and paper processing applications. In yet another embodiment, the products are used to provide antiblock and/or reinforcing properties to polymers. In yet a further embodiment, the products are used as abrasives. In still another embodiment, the products are used for buffing. In still a further embodiment, the products are used as polishing compositions. In another embodiment, the products are used in the processing and preparation of catalysts. In a further embodiment, the products are used as chromatographic supports or other support media. In yet another embodiment, the products are blended, mixed, or otherwise combined with other ingredients to make monolithic or aggregate media useful in a variety of applications, including but not limited to supports (for example, for microbe immobilization), substrates (for example, for enzyme immobilization), or in the preparation of catalysts.

Unless otherwise indicated, all numbers expressing quantities of ingredients, reaction conditions, and so forth used in the specification, including claims, are to be understood as being modified in all instances by the term “about.” Accordingly, unless otherwise indicated to the contrary, the numerical parameters are approximations and may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### EXAMPLES

### Example One

Various samples of freshwater diatomite were analyzed to determine their Beer Soluble Iron (“BSI”) content both before and after treatment with a soluble metal blocking agent in accordance with the present invention. The samples of freshwater diatomite measured about 25 g each and were treated with a given amount of the soluble metal blocking agent Silquest® A1100 in a closed container and incubated at 105° C. for at least 10 minutes to allow the molecules of the blocking agent to cover the surfaces of the diatomite. The BSI contents were measured according to both the ASBC and EBC methods. The samples of freshwater diatomite tested were all commercially available from World Minerals, Inc. The results of the testing appear in Table 1.

TABLE 1

| | | % Treatment | | | | |
|---|---|---|---|---|---|---|
| | | Agent | | | | |
| Freshwater | Treatment | (by weight of | ASBC Scale | | EBC Scale | |
| Diatomite | Agent | diatomite) | BSI (ppm) | % Change | BSI (ppm) | % Change |
| Celite ® 535R | Untreated | 0.00 | 28.1 | 100% | 58.4 | 85% |
| Celite ® 535R | Silquest A1100 | 0.40 | 0.0 | | 8.5 | |
| Celite ® 503 | Untreated | 0.00 | 34.3 | 100% | 66.3 | 83% |
| Celite ® 503 | Silquest A1100 | 0.48 | 0.0 | | 11.0 | |
| Celite ® 577 | Untreated | 0.00 | 7.3 | 89% | 63.7 | 19% |
| Celite ® 577 | Silquest A1100 | 0.60 | 0.8 | | 51.7 | |
| Kenite ® 200 | Untreated | 0.00 | 6.0 | 90% | 80.9 | 45% |
| Kenite ® 200 | Silquest A1100 | 0.44 | 0.6 | | 44.4 | |
| Kenite ® 300 | Untreated | 0.00 | 105.4 | 98% | 176.4 | 59% |
| Kenite ® 300 | Silquest A1100 | 0.40 | 2.3 | | 72.1 | |
| Kenite ® 1000 | Untreated | 0.00 | 86.3 | — | 149.6 | — |
| Kenite ® 1000 | Silquest A1100 | 0.24 | 9.4 | 89% | 82.4 | 45% |
| Kenite ® 1000 | Silquest A1100 | 0.48 | 0.0 | 100% | 42.5 | 72% |
| Kenite ® 1000 | Silquest A1100 | 1.00 | 0.0 | 100% | 40.5 | 73% |
| Super Floss ® | Untreated | 0.00 | 48.1 | 100% | 77.6 | 58% |
| Super Floss ® | Silquest A1100 | 0.60 | 0.0 | | 32.4 | |

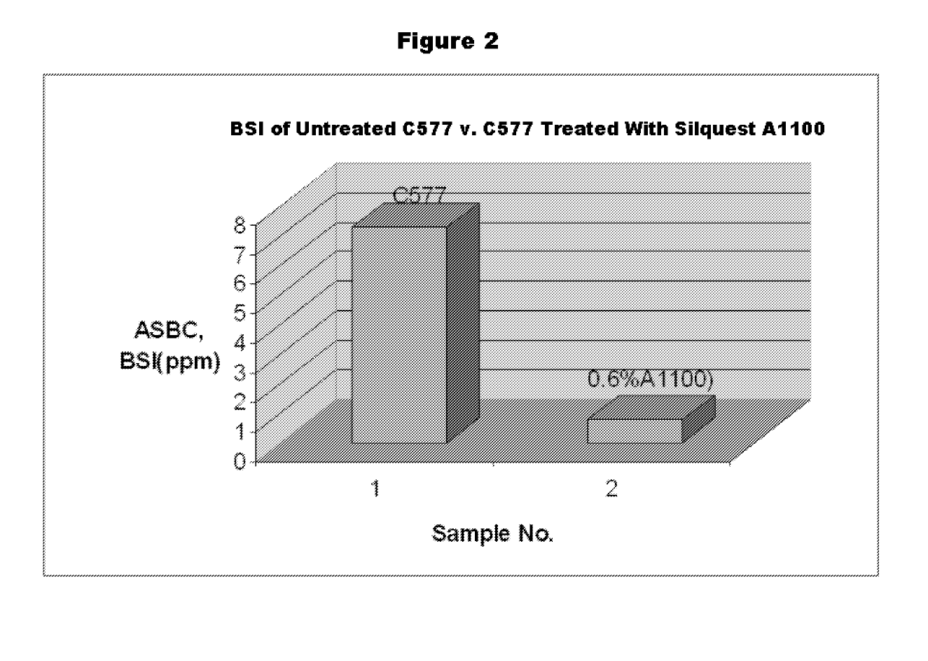

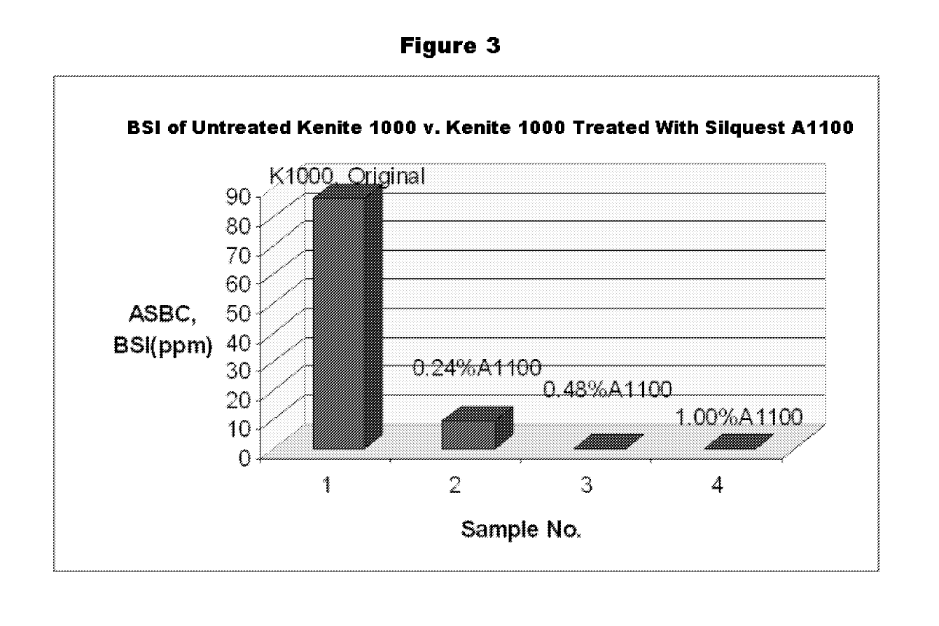

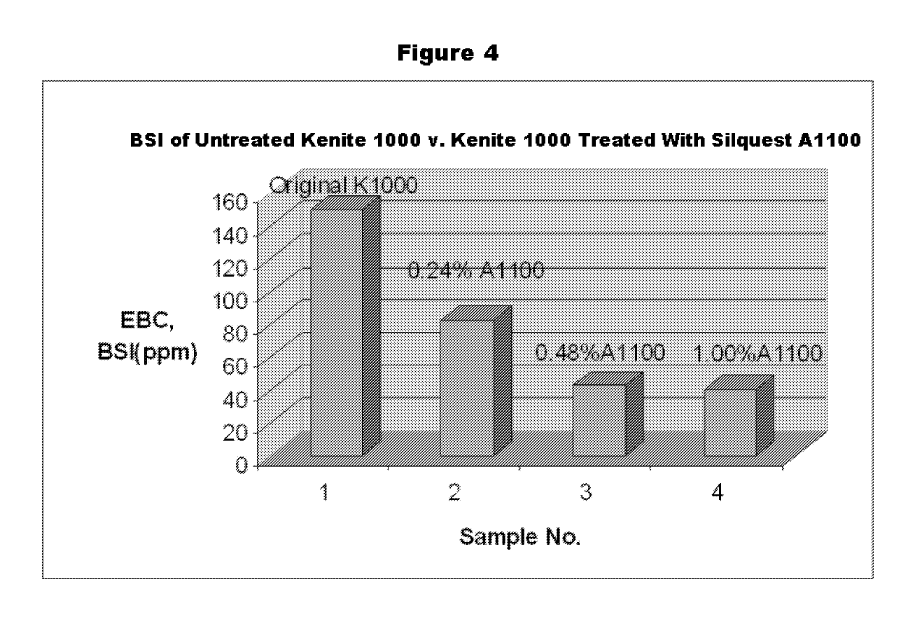

Freshwater diatomites treated with Silquest A1100 showed significant reduction of BSI over freshwater diatomites without such treatment. Unexpectedly and surprisingly, the results indicate that, by using a small amount of the surface metal blocking agent (e.g., <1%), the dissolution of beer soluble irons can be effectively blocked. On the ASBC scale, many DE samples measured no BSI after treatment with Silquest A1100 and all samples measured BSI reductions of more than 89%. On the EBC scale, most DE samples measured BSI reductions of 45% or more after treatment with Silquest A1100. Selected results from Table 1 are illustrated in FIGS. 2-4.

### Example Two

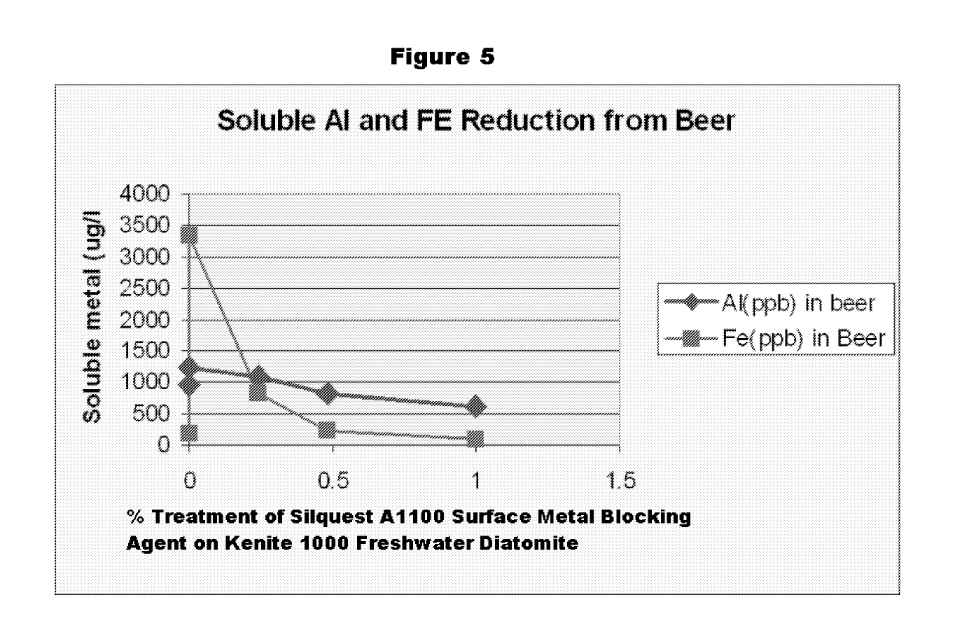

In an additional test, treated freshwater DE material according to the instant invention not only exhibited reduced BSI levels, but also provided enough soluble metal blocking agent to extract soluble metals from the liquid being filtered. FIG. 5 illustrates the reduction of soluble metals (both iron and aluminum) from a sample of Budweiser® beer filtered with a freshwater diatomite material treated with Kenite® 1000 according to the instant invention at the treatment percentages shown. In the experiment, 1000 ml of Budweiser® beer was contacted with 25 g of an untreated diatomite for 6 minutes and filtered. Subsequent to contact with the untreated diatomite, the filtered beer exhibited elevated levels of both soluble iron and aluminum. The filtered beer was then mixed with a surface-treated freshwater diatomite according to the instant invention for 6 minutes and filtered again. As can be seen from the results in FIG. 5, metals spiked into the beer by contact with the untreated diatomite were effectively reduced or removed from the beer after filtration with the surface-treated diatomite according to the instant invention. The soluble iron and aluminum in the beer were measured by a graphite furnace atomic absorption spectrometric (GFAA) method.

1. A process for decreasing the soluble metal content of at least one freshwater diatomaceous earth material, comprising treating the at least one freshwater diatomaceous earth material with at least one soluble metal blocking agent comprising at least one organic silicon component and at least one chelating functional group.

2. The process of claim 1, wherein the at least one chelating functional group is chosen from amino, phenyl, azide, carboxylate, phosphonate, sulfonate, epoxy, glycidoxy, vinyl, methacryl, isocyanato, mercaptan, and hydroxy groups.

3. The process of claim 1, wherein the at least one organic silicon component is chosen from silanes, siloxanes, and silicones.

4. The process of claim 1, wherein the at least one soluble metal blocking agent is chosen from 3-aminopropyltriethoxysilane, 3-glycidoxypropyltrimethoxysilane, 3,4-epoxycyclohexyl ethyltrimethoxy silane, N-(2-Aminoethyl)-3-aminopropyltrialkoxysilane, N-(Aminoethyl)-3-aminopropylmethyldialkoxysilane, 3-ureidopropyltrialkoxysilane, vinyltrialkoxysilane, vinyldimethoxymethylsilane, vinyltris(2-methoxyethoxy)-silane, vinyltriacetoxysilane, (Methacryloxymethyl)methyldialkoxysilane, Methacryloxymethyltrimethoxysilane, Methacryloxypropyltrialkoxysilane, 3-Methacryloxypropyltrimethoxysilane, 3-Methacryloxypropyltriacetoxysilane, 3-Isocyanatopropyltrimethoxysilane, (Isocyanatomethyl)methyldimethoxysilane, and 3-Glycidoxypropylmethyldiethoxysilane.

5. The process of claim 4, wherein the at least one soluble metal blocking agent is chosen from 3-glycidoxypropyltrimethoxysilane and 3-aminopropyltriethoxysilane.

6. The process of claim 1, wherein the material is treated with the at least one soluble metal blocking agent in an amount ranging from about 0.2% to about 2%, relative to the weight of the at least one freshwater diatomaceous earth feed material.

7. The process of claim 6, wherein the material is treated with the at least one soluble metal blocking agent in an amount ranging from about 0.2% to about 0.6%, relative to the weight of the at least one freshwater diatomaceous earth feed material.

8. The process of claim 1, wherein the beer soluble iron content of the freshwater diatomaceous earth material is reduced by at least about 45%, as measured by the EBC method.

9. The process of claim 8, wherein the beer soluble iron content of the freshwater diatomaceous earth material is reduced by at least about 70%, as measured by the EBC method.

10. (canceled)

11. The process of claim 1, wherein the beer soluble iron content of the freshwater diatomaceous earth material is reduced by at least about 90%, as measured by the ASBC method.

12-25. (canceled)

26. A treated freshwater diatomaceous earth product, comprising:
a freshwater diatomaceous earth material; and,
at least one soluble metal blocking agent comprising at least one organic silicon component and at least one chelating functional group.

27. The product of claim 26, wherein the at least one chelating functional group is chosen from amino, phenyl, azide, carboxylate, phosphonate, sulfonate, epoxy, glycidoxy, vinyl, methacryl, isocyanato, mercaptan, and hydroxy groups.

28. The product of claim 26, wherein the at least one organic silicon component is chosen from silanes, siloxanes, and silicones.

29. The product of claim 26, wherein the at least one soluble metal blocking agent is chosen from of 3-aminopropyltriethoxysilane, 3-glycidoxypropyltrimethoxysilane, 3,4-epoxycyclohexyl ethyltrimethoxy silane, N-(2-Aminoethyl)-3-aminopropyltrialkoxysilane, N-(Aminoethyl)-3-aminopropylmethyldialkoxysilane, 3-ureidopropyltrialkoxysilane, vinyltrialkoxysilane, vinyldimethoxymethylsilane, vinyltris(2-methoxyethoxy)-silane, vinyltriacetoxysilane, (Methacryloxymethyl)methyldialkoxysilane, Methacryloxymethyltrimethoxysilane, Methacryloxypropyltrialkoxysilane, 3-Methacryloxypropyltrimethoxysilane, 3-Methacryloxypropyltriacetoxysilane, 3-Isocyanatopropyltrimethoxysilane, (Isocyanatomethyl)methyldimethoxysilane, and 3-Glycidoxypropylmethyldiethoxysilane.

30. The product of claim 29, wherein the at least one soluble metal blocking agent is chosen from 3-glycidoxypropyltrimethoxysilane and 3-aminopropyltriethoxysilane.

31. (canceled)

32. A method of filtering a liquid, comprising passing the liquid through at least one filter membrane comprising a treated freshwater diatomaceous earth product, comprising:
a freshwater diatomaceous earth material; and,
at least one soluble metal blocking agent comprising at least one organic silicon component and at least one chelating functional group.

33. The method of claim 32, wherein the at least one soluble metal blocking agent is present in an amount ranging from about 0.2% to about 2%, relative to the weight of the at least one freshwater diatomaceous earth material.

34-36. (canceled)

37. The method of claim 32, wherein the beverage liquid is a beer.

38. The method of claim 37, wherein the beer soluble iron content of the beer is reduced by at least about 70%, as measured by the EBC method.

39. The method of claim 37, wherein the beer soluble iron content of the beer is reduced by at least about 80%, as measured by the ASBC method.

40-42. (canceled)
